(19) United States
(12) Patent Application Publication
(10) Pub. No.: US 2025/0347576 A1
(43) Pub. Date: Nov. 13, 2025

(54) LIQUID LEAKAGE DETECTION DEVICE AND LIQUID LEAKAGE DETECTION SENSOR

(71) Applicant: SHENZHEN ENVICOOL TECHNOLOGY CO., LTD., Shenzhen (CN)

(72) Inventors: Xiaoxin XU, Shenzhen (CN); Xiaolei AI, Shenzhen (CN); Xiaojin CHENG, Shenzhen (CN); Zhen XIONG, Shenzhen (CN); Feng LV, Shenzhen (CN)

(73) Assignee: SHENZHEN ENVICOOL TECHNOLOGY CO., LTD., Shenzhen (CN)

(21) Appl. No.: 18/805,977

(22) Filed: Aug. 15, 2024

(30) Foreign Application Priority Data
May 10, 2024 (CN) 202421015170.2

(51) Int. Cl. G01M 3/18

(52) U.S. Cl. CPC G01M 3/18

(57) ABSTRACT

A liquid leakage detection sensor includes a first liquid leakage detection portion and a second liquid leakage detection portion, and the first liquid leakage detection portion and the second liquid leakage detection portion are integrally formed. The first liquid leakage detection portion is arranged at a first liquid leakage detection position of a liquid cooling device to detect liquid leakage at the first liquid leakage detection position, and the second liquid leakage detection portion is arranged at a second liquid leakage detection position of the liquid cooling device to detect liquid leakage at the second liquid leakage detection position. The first liquid leakage detection portion and the second liquid leakage detection portion are integrally formed, and need not to be connected by an insertion connector.

### CROSS REFERENCE TO RELATED APPLICATIONS

This application claims the priorities to Chinese patent application No. 202421015170.2, titled “LIQUID LEAKAGE DETECTION DEVICE AND LIQUID LEAKAGE DETECTION SENSOR”, filed with the China National Intellectual Property Administration May 10, 2024, the entire disclosure of which is hereby incorporated by reference.

### FIELD

The present application relates to the technical field of liquid cooling devices, and in particular to a liquid leakage detection device and a liquid leakage detection sensor.

### BACKGROUND

A heat generating device is cooled by a liquid cooling device with a cooling medium. During operation of the liquid cooling device, liquid leakage may occur, causing damage to the heat generating device. Therefore, liquid leakage needs to be detected in the liquid cooling device to ensure the normal operation of the liquid cooling device and the heat generating device.

One liquid leakage detection method for the liquid cooling device is to wind a liquid leakage detection cable around a supply pipeline for detection. For a liquid cooling device having many liquid leakage detection positions, multiple liquid leakage detectors are needed, and each liquid leakage detector has to be connected to another liquid leakage detector or a liquid leakage collector through an insertion connector.

At least following problems emerge during implementation of the present application.

It has been found through long-term practice that, the above technical solution has the following problems. If there are a lot of liquid leakage detection positions on the liquid cooling device, too many insertion connectors are needed, which adds the workload to an installer, and increases a risk of disconnection. Moreover, identification of the liquid leakage may be affected if there is a liquid or other conductive substance inside the insertion connectors.

Therefore, a technical problem to be solved by those skilled in the art is how to improve installation convenience and detection accuracy of the liquid leakage detection sensor.

### SUMMARY

An object of the present application is to provide a liquid leakage detection device and a liquid leakage detection sensor, so as to effectively prevent an insertion connector from having a negative impact on installation and detection of the liquid leakage detection sensor.

To achieve the above object, the following technical solutions are provided according to the present application.

A liquid leakage detection sensor includes a first liquid leakage detection portion for detecting liquid leakage at a first liquid leakage detection position of a liquid cooling device and a second liquid leakage detection portion for detecting liquid leakage at a second liquid leakage detection position of the liquid cooling device, and the first liquid leakage detection portion and the second liquid leakage detection portion are integrally formed.

In some embodiments, the first liquid leakage detection portion and/or the second liquid leakage detection portion are each provided with a connection terminal that is in connection with another liquid leakage detection sensor or liquid leakage collector.

In some embodiments, the first liquid leakage detection portion is a liquid leakage detection band for detecting liquid leakage from a supply pipeline of the liquid cooling device.

In some embodiments, the second liquid leakage detection portion is a liquid leakage detection sheet for detecting liquid leakage from a liquid cooling plate of the liquid cooling device.

In some embodiments, the liquid leakage detection sensor includes a third liquid leakage detection portion, and the first liquid leakage detection portion, the second liquid leakage detection portion, and the third liquid leakage detection portion are distributed in a listed sequence and are integrally formed.

In some embodiments, the first liquid leakage detection portion includes a first detection body, a first extension portion, and a connector extension portion;
the first extension portion is located at a lateral end of the first detection body, the connector extension portion is located at the lateral end of the first detection body, and the connection terminal is located at the connector extension portion and is away from the lateral end of the first detection body; and
the second liquid leakage detection portion includes a second detection body and a second extension portion, the second extension portion is located at the end of the first detection body, and the second extension portion and the first extension portion are integrally formed.

In some embodiments, the first detection body and the second detection body each includes a first liquid leakage detection wire and a second liquid leakage detection wire that are spaced apart from each other; and
a lateral portion of the first liquid leakage detection wire is provided with multiple first detection sheets extending towards the second liquid leakage detection wire, and a lateral portion of the second liquid leakage detection wire is provided with multiple second detection sheets extending towards the first liquid leakage detection wire.

In some embodiments, the multiple first detection sheets and the multiple second detection sheets are distributed alternatively and are spaced apart from each other in sequence.

In some embodiments, the liquid leakage detection sheet is covered on a plane to be detected at the second liquid leakage detection position.

A liquid leakage detection device includes the liquid leakage detection sensor according to any one of the above technical solutions.

The above technical solutions have at least the following advantages.

The liquid leakage detection device and the liquid leakage detection sensor according to the present application include the first liquid leakage detection portion and the second liquid leakage detection portion. The first liquid leakage detection portion and the second liquid leakage detection portion are integrally formed, and need not to be connected by an insertion connector. Therefore, compared with a conventional solution that they are connected by the insertion connector, installation thereof becomes easier. Workload of an installer is significantly reduced, especially in a case that the liquid cooling device has many liquid leakage detection positions. Moreover, problems of disconnection or false liquid leakage at the insertion connector are eliminated, thereby effectively enhancing the liquid leakage detection performance.

### BRIEF DESCRIPTION OF THE DRAWINGS

For more clearly illustrating embodiments of the present application or the technical solutions in the prior art, drawings referred to describe the embodiments or the prior art will be briefly described hereinafter. Apparently, the drawings in the following descriptions are only examples of the present application, and for those skilled in the art, other drawings may be obtained based on these drawings without any creative efforts.

FIG. 1 is a schematic structural view of a liquid leakage detection sensor according to an embodiment of the present application.

### REFERENCE NUMERALS

| | | | |
|---|---|---|---|
| 10 | first liquid leakage detection | 11 | first extension portion, |
| | portion, | | |
| 12 | connector extension portion, | 121 | connection terminal, |
| 13 | first detection sheet, | 14 | second detection sheet, |
| 20 | second liquid leakage detection | 21 | second extension portion, |
| | portion, | | |
| 30 | third liquid leakage detection | | |
| | portion. | | |

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments of the present application, rather than all of the embodiments. All the other embodiments obtained by those skilled in the art based on the embodiments in the present application without any creative work belong to the scope of protection of the present application.

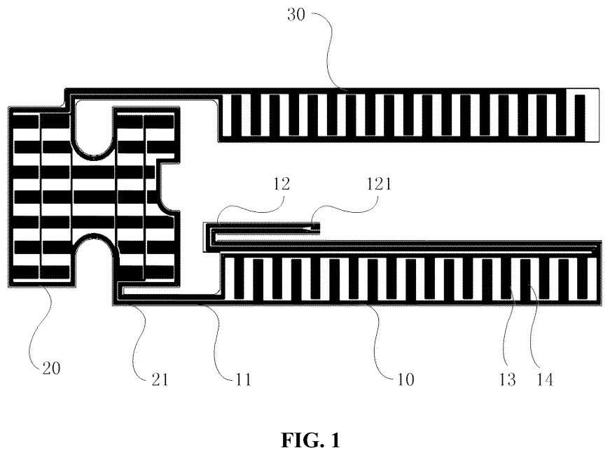

Referring to FIG. 1. FIG. 1 is a schematic structural view of a liquid leakage detection sensor according to an embodiment of the present application.

A liquid leakage detection sensor is provided according to the present application, including a first liquid leakage detection portion 10 and a second liquid leakage detection portion 20, and the first liquid leakage detection portion 10 and the second liquid leakage detection portion 20 are integrally formed. Generally, the first liquid leakage detection portion 10 and the second liquid leakage detection portion 20 each includes a first liquid leakage detection wire and a second liquid leakage detection wire. When liquid leakage in a liquid cooling device contacts both the first liquid leakage detection wire and the second liquid leakage detection wire, the first liquid leakage detection wire and the second liquid leakage detection wire are short-circuited, which indicates that liquid leakage occurs in the liquid cooling device. In actual use, the first liquid leakage detection portion 10 is arranged at a first liquid leakage detection position of the liquid cooling device to detect liquid leakage at the first liquid leakage detection position, and the second liquid leakage detection portion 20 is arranged at a second liquid leakage detection position of the liquid cooling device to detect liquid leakage at the second liquid leakage detection position. The first liquid leakage detection position and the second liquid leakage detection position are different liquid leakage detection positions on the liquid cooling device. The first liquid leakage detection portion 10 and the second liquid leakage detection portion 20 according to the present application are integrally formed, and need not to be connected by an insertion connector, thus, compared with a solution that they are connected by the insertion connector, installation thereof becomes easier. Workload of an installer is significantly reduced, especially in a case that the liquid cooling device has many liquid leakage detection positions. Moreover, problems of disconnection or false liquid leakage at the insertion connector are eliminated, thereby effectively enhancing the liquid leakage detection performance.

It should be noted that, a case that two liquid leakage detection portions are provided is described as an example in the above embodiment. In an actual product, more liquid leakage detection portions may be provided. The liquid leakage detection portions are integrally formed into one liquid leakage detection sensor, and the insertion connector or other connection means are not needed for assembling the liquid leakage detection portions. In addition, some liquid leakage detection portions of the liquid leakage detection sensor may be connected by the insertion connector, while not all the liquid leakage detection portions are connected by the insertion connector.

In some embodiments, the first liquid leakage detection portion 10 and/or the second liquid leakage detection portion 20 are provided with a connection terminal 121 in connection with another liquid leakage detection sensor or liquid leakage collector. That is, the first liquid leakage detection portion 10 and the second liquid leakage detection portion 20 share the same connection terminal 121, and the connection terminal 121 may be a gold finger. For a liquid cooling device with more detection positions, each of the first liquid leakage detection portion 10 and the second liquid leakage detection portion 20 may be provided with a connection terminal 121. Through one of the two connection terminals 121, the liquid leakage detection sensor having such structure can be connected to another liquid leakage detection sensor having the same structure by an insertion connector, or be connected to another normal liquid leakage detection sensor by an insertion connector. The other one of the two connection terminals 121 is connected to the liquid leakage collector by an insertion connector. As shown in FIG. 1, for example, an end of the first liquid leakage detection portion 10 away from the second liquid leakage detection portion 20 is provided with the connection terminal 121. The connection terminal 121 is provided with a reinforcement plate, or the connection terminal 121 is thickened, i.e. a thickness of the connection terminal 121 is greater than a thickness of the first liquid leakage detection portion 10, thereby enhancing structural strength of the connection terminal 121.

In some embodiments, the liquid cooling device includes a supply pipeline and a liquid cooling plate. A chamber is provided inside the liquid cooling plate, and the supply pipeline is in communication with the chamber inside the liquid cooling plate. The liquid cooling plate dissipates heat from a heat generating device on a server, such as a processor. The liquid cooling plate may be provided with a liquid collection groove, and liquid leakage in the liquid cooling plate may flow into the liquid collection groove. The first liquid leakage detection portion 10 of the liquid leakage detection sensor is a liquid leakage detection band, and the liquid leakage detection band is used to detect liquid leakage from the supply pipeline of the liquid cooling device. The second liquid leakage detection portion 20 is a liquid leakage detection sheet, and the liquid leakage detection sheet is used to detect liquid leakage from the liquid cooling plate of the liquid cooling device. The liquid leakage detection band and the liquid leakage detection sheet are integrally formed. Specifically, a first liquid leakage detection wire of the liquid leakage detection band and a first liquid leakage detection wire of the liquid leakage detection sheet are the same wire, and a second liquid leakage detection wire of the liquid leakage detection band and a second liquid leakage detection wire of the liquid leakage detection sheet are the same wire.

It should be noted that, the liquid leakage detection band further includes a base band for the arrangement of the first liquid leakage detection wire and the second liquid leakage detection wire, and the first liquid leakage detection wire and the second liquid leakage detection wire arranged on the base band extend along a length direction of the base band. The liquid leakage detection sheet further includes a base sheet for the arrangement of the first liquid leakage detection wire and the second liquid leakage detection wire. In a case that the liquid leakage detection sheet is of a rectangular structure, the first liquid leakage detection wire is distributed along two adjacent edges, and the second liquid leakage detection wire is distributed along the other two adjacent edges. A lateral portion of the first liquid leakage detection wire may be provided with a first branch liquid leakage detection wire, and a lateral portion of the second liquid leakage detection wire may be provided with a second branch liquid leakage detection wire. The first branch liquid leakage detection wire and the second branch liquid leakage detection wire are arranged inside a region enclosed by the first liquid leakage detection wire and the second liquid leakage detection wire. The number of the first branch liquid leakage detection wire and the number of the second branch liquid leakage detection wire may be selected according to an area of the base sheet. The number of the first branch liquid leakage detection wire and the number of the second branch liquid leakage detection wire increase with the area of the base sheet. When the liquid leakage contacts the first liquid leakage detection wire and the second branch liquid leakage detection wire at the same time, or contacts the second liquid leakage detection wire and the first branch liquid leakage detection wire at the same time, or contacts the first branch liquid leakage detection wire and the second branch liquid leakage detection wire at the same time, a short-circuit occurs at the liquid leakage detection sensor. The base band and the base sheet are integrally formed, i.e. there is no connector between the base band and the base sheet. In use, the liquid leakage detection band and the liquid leakage detection sheet only need to be arranged at corresponding detection positions rather than being connected by an insertion connector. Therefore, workload of the installer is significantly reduced.

In some embodiments, the liquid leakage detection sensor further includes a third liquid leakage detection portion 30, and the first liquid leakage detection portion 10, the second liquid leakage detection portion 20, and the third liquid leakage detection portion 30 are distributed in a listed sequence and are integrally formed. In a case that the liquid cooling device has two supply pipelines and one liquid cooling plate, one of the two supply pipelines is in communication with a liquid inlet of the liquid cooling plate, and a liquid outlet of the liquid cooling plate is in communication with the other one of the two supply pipelines. In this case, the third liquid leakage detection portion 30 is a liquid leakage detection band.

It should be noted that, the solution that, the first liquid leakage detection portion 10 and the third liquid leakage detection portion 30 are liquid leakage detection bands, and the second liquid leakage detection portion 20 is a liquid leakage detection sheet according to the above embodiment, is only an example of the liquid cooling device having a specific structure for description. For a liquid cooling device of other structures, a liquid leakage detection sensor having a corresponding structure is selected. For example, the first liquid leakage detection portion 10, the second liquid leakage detection portion 20, and the third liquid leakage detection portion 30 may all be liquid leakage detection bands or may all be liquid leakage detection sheets. Or, at least some are liquid leakage detection bands, and others are liquid leakage detection sheets. Or, at least one of the first liquid leakage detection portion 10, the second liquid leakage detection portion 20, and the third liquid leakage detection portion 30 is of a combined structure of the liquid leakage detection band and the liquid leakage detection sheet. The distributions of the liquid leakage detection band and the liquid leakage detection sheet may be selected according to the specific liquid cooling device.

In some embodiments, as shown in FIG. 1, the first liquid leakage detection portion 10 includes a first detection body, a first extension portion 11, and a connector extension portion 12. An outer pipe is mounted outside the supply pipeline. When the first liquid leakage detection portion 10 is a liquid leakage detection band, the first detection body is of a band structure, and is arranged on an inner wall of the outer pipe. Specifically, the first detection body is attached on the inner wall of the outer pipe by an adhesive. The first detection body extends along an axial direction of the outer pipe. The first extension portion 11 is located at a lateral end of the first detection body, and the connector extension portion 12 is located at the lateral end of the first detection body. The connection terminal 121 is located at the connector extension portion 12 and is away from the lateral end of the first detection body. The second liquid leakage detection portion 20 includes a second detection body and a second extension portion 21. The second extension portion 21 is located at the lateral end of the first detection body, and the second extension portion 21 and the first extension portion 11 are integrally formed. To improve structural strength of the liquid leakage detection sensor, a surface of the first extension portion 11, a surface of the second extension portion 21, and a surface of the connector extension portion 12 are each provided with a reinforcement plate, or the first extension portion 11, the second extension portion 21, and the connector extension portion 12 are thickened, so as to prevent each extension portion from being ripped. When the second liquid leakage detection portion 20 is a liquid leakage detection sheet, the second detection body is of a sheet structure. The liquid leakage detection sheet may be covered on a plane to be detected at the second liquid leakage detection position. For example, the liquid leakage detection sheet may be attached to an inner bottom surface of the liquid collection groove by an adhesive. To avoid a liquid inlet connector, a liquid outlet connector, and a liquid suction port on the liquid collection groove, the liquid leakage detection sheet is provided with a liquid inlet avoidance notch, a liquid outlet avoidance notch, and a liquid suction avoidance notch. The liquid leakage inside the liquid collection groove can flow to the liquid suction port. A suction pipe is located above the liquid suction port, and can suck the liquid leakage out, so as to prevent the liquid leakage stored inside the liquid collection groove from overflowing and affecting normal operation of the heat generating device, and even causing irreversible damage to the heat generating device.

In some embodiments, the first liquid leakage detection wire and the second liquid leakage detection wire of the first detection body are spaced apart from each other, and the first liquid leakage detection wire and the second liquid leakage detection wire of the second detection body are spaced apart from each other. The lateral portion of the first liquid leakage detection wire is provided with multiple first detection sheets 13 extending towards the second liquid leakage detection wire, and the lateral portion of the second liquid leakage detection wire is provided with multiple second detection sheets 14 extending towards the first liquid leakage detection wire. When the liquid leakage contacts the first detection sheet 13 and the second detection sheet 14, or contacts the first detection sheet 13 and the second liquid leakage detection wire, or contacts the first liquid leakage detection wire and the second detection sheet 14, the liquid leakage can be detected due to short-circuit. Therefore, a detection area of the liquid leakage detection sensor is enlarged by the first detection sheet 13 and the second detection sheet 14. The multiple first detection sheets 13 and the multiple second detection sheets 14 are distributed alternatively and are spaced apart from each other in sequence, and are distributed in a staggered manner. The multiple first detection sheets 13 may be equally spaced apart along a length extension direction of the first liquid leakage detection wire, and the multiple second detection sheets 14 may be equally spaced apart along a length extension direction of the second liquid leakage detection wire.

It should be noted that, the multiple first detection sheets 13 and the multiple second detection sheets 14 may each be of a rectangular structure, or may be of other structures, as long as each is of a continuous structure extending from the side portion of the first liquid leakage detection wire and the side portion of the second liquid leakage detection wire respectively.

A liquid leakage detection device is further provided according to an embodiment of the present application. The liquid leakage detection device may be applied to liquid leakage detection of the liquid cooling device, and the liquid cooling device may be used for cooling of a server or other electronic devices having a heat generating device. Liquid leakage detection positions of the liquid cooling device include a position of the supply pipeline, a position of the liquid cooling plate, and a position of the connector between the supply pipeline and the liquid cooling plate. The supply pipeline is configured to supply a coolant, and liquid leakage at the connector can drop into the liquid collection groove. Thus, liquid leakage from the supply pipeline can be detected by the first liquid leakage detection portion 10, and liquid leakage from the liquid cooling plate and the connector can be detected by the second liquid leakage detection portion 20. The liquid leakage detection device includes the liquid leakage detection sensor according to any one of the above embodiments, and a liquid leakage collector connected to the liquid leakage detection sensor. The liquid leakage collector captures a signal being produced when the first liquid leakage detection wire and the second liquid leakage detection wire of the liquid leakage detection sensor are conducted through the liquid leakage. Specifically, the liquid leakage collector includes a detection circuit, and the detection circuit is provided with a resistor. The liquid leakage detection sensor is connected to the resistor in parallel. When short-circuit occurs in the liquid leakage detection sensor, a current in the detection circuit will flow through the liquid leakage detection sensor, and the liquid leakage in the liquid cooling device can be detected at this time.

It should be noted that, in this specification, relational terms such as “first” and “second” are merely intended to distinguish one entity from other entities, and do not require or imply any actual relationships or sequences among these entities.

The above embodiments in this specification are described in a progressive manner. Each of the embodiments is mainly focused on describing its differences from other embodiments, and references may be made among these embodiments with respect to the same or similar portions among these embodiments.

A liquid leakage detection device and a liquid leakage detection sensor according to the present application are described in detail hereinbefore. The principle and the embodiments of the present application are illustrated herein by specific examples. The above description of examples is only intended to help the understanding of the method and the idea of the present application. It should be noted that, for those skilled in the art, a few of modifications and improvements may be made to the present application without departing from the principle of the present application, and these modifications and improvements are deemed to fall into the protection scope of the present application defined by the claims.

1. A liquid leakage detection sensor, comprising:
a first liquid leakage detection portion for detecting liquid leakage at a first liquid leakage detection position of a liquid cooling device, and
a second liquid leakage detection portion for detecting liquid leakage at a second liquid leakage detection position of the liquid cooling device,
wherein the first liquid leakage detection portion and the second liquid leakage detection portion are integrally formed.

2. The liquid leakage detection sensor according to claim 1, wherein the first liquid leakage detection portion and/or the second liquid leakage detection portion are each provided with a connection terminal that is in connection with another liquid leakage detection sensor or a liquid leakage collector.

3. The liquid leakage detection sensor according to claim 2, wherein the first liquid leakage detection portion is a liquid leakage detection band for detecting liquid leakage from a supply pipeline of the liquid cooling device.

4. The liquid leakage detection sensor according to claim 3, wherein the second liquid leakage detection portion is a liquid leakage detection sheet for detecting liquid leakage from a liquid cooling plate of the liquid cooling device.

5. The liquid leakage detection sensor according to claim 4, wherein the liquid leakage detection sensor comprises a third liquid leakage detection portion, and the first liquid leakage detection portion, the second liquid leakage detection portion, and the third liquid leakage detection portion are distributed in a listed sequence and are integrally formed.

6. The liquid leakage detection sensor according to claim 2, wherein
the first liquid leakage detection portion comprises a first detection body, a first extension portion, and a connector extension portion;
the first extension portion is located at a lateral end of the first detection body, the connector extension portion is located at the lateral end of the first detection body, and the connection terminal is located at the connector extension portion and is away from the lateral end of the first detection body; and
the second liquid leakage detection portion comprises a second detection body and a second extension portion, the second extension portion is located at the lateral end of the first detection body, and the second extension portion and the first extension portion are integrally formed.

7. The liquid leakage detection sensor according to claim 6, wherein
the first detection body and the second detection body each comprises a first liquid leakage detection wire and a second liquid leakage detection wire that are spaced apart from each other; and
a lateral portion of the first liquid leakage detection wire is provided with a plurality of first detection sheets extending towards the second liquid leakage detection wire, and a lateral portion of the second liquid leakage detection wire is provided with a plurality of second detection sheets extending towards the first liquid leakage detection wire.

8. The liquid leakage detection sensor according to claim 7, wherein the plurality of first detection sheets and the plurality of second detection sheets are distributed alternatively and are spaced apart from each other in sequence.

9. The liquid leakage detection sensor according to claim 4, wherein the liquid leakage detection sheet is covered on a plane to be detected at the second liquid leakage detection position.

10. A liquid leakage detection device, comprising the liquid leakage detection sensor according to claim 1.

11. A liquid leakage detection device, comprising the liquid leakage detection sensor according to claim 2.

12. A liquid leakage detection device, comprising the liquid leakage detection sensor according to claim 3.

13. A liquid leakage detection device, comprising the liquid leakage detection sensor according to claim 4.

14. A liquid leakage detection device, comprising the liquid leakage detection sensor according to claim 5.

15. A liquid leakage detection device, comprising the liquid leakage detection sensor according to claim 6.

16. A liquid leakage detection device, comprising the liquid leakage detection sensor according to claim 7.

17. A liquid leakage detection device, comprising the liquid leakage detection sensor according to claim 8.

18. A liquid leakage detection device, comprising the liquid leakage detection sensor according to claim 9.
